(19) United States
(12) Patent Application Publication
(10) Pub. No.: US 2009/0283721 A1
(43) Pub. Date: Nov. 19, 2009

(54) NITRIDE-BASED RED PHOSPHORS

(75) Inventors: Shengfeng Liu, Fremont, CA (US); Dejie Tao, Fremont, CA (US); Xianglong Yuan, Fremont, CA (US); Yi-Qun Li, Danville, CA (US)

Correspondence Address: FLIESLER MEYER LLP, 650 CALIFORNIA STREET, 14TH FLOOR, SAN FRANCISCO, CA, 94108, US

(73) Assignee: Intematix Corporation, Fremont, CA (US)

(21) Appl. No.: 12/250,400

(22) Filed: Oct. 13, 2008

Related U.S. Application Data
(60) Provisional application No. 61/054,399, filed on May 19, 2008.

(51) Int. Cl. C09K 11/85

(52) U.S. Cl. 252/301.4 H

(57) ABSTRACT

Embodiments of the present invention are directed to the fluorescence of a nitride-based deep red phosphor having at least one of the following novel features: 1) an oxygen content less than about 2 percent by weight, and 2) a halogen content. Such phosphors are particularly useful in the white light illumination industry, which utilizes the so-called “white LED.” The selection and use of a rare earth halide as a raw material source of not only the activator for the phosphor, but also the halogen, is a key feature of the present embodiments. The present phosphors have the general formula MₐM_{b}B_{C}(N,D):Eu²⁺, where Mₐ is a divalent alkaline earth metal such as Mg, Ca, Sr, Ba; M_{b} is a trivalent metal such as Al, Ga, Bi, Y, La, and Sm; and M_{c} is a tetravalent element such as Si, Ge, P, and B; N is nitrogen, and D is a halogen such as F, Cl, or Br. An exemplary compound is CaAlSi(N₁₋ₓFₓ): Eu²⁺.

### CLAIM OF PRIORITY

The present application claims priority to U.S. Patent application 61/054,399 titled “Nitridosilicate-based red phosphors,” by Liu et al., filed May 19, 2008. U.S. provisional 61/054,399 is herein incorporated in its entirety.

### FIELD OF THE INVENTION

Embodiments of the present invention are directed to nitridosilicate-based phosphor compounds emitting in the red region of the electromagnetic spectrum. The present compounds exhibit enhanced photoluminescent intensities and longer emission wavelengths than that offered by conventional red nitrides, and thus the present compounds are particularly useful in the white LED lighting industry.

### BACKGROUND

Conventionally, nitridosilicate-based phosphor compounds have contained an alkaline earth metal element (such as Mg, Ca, Sr, and Ba), silicon, nitrogen, and a rare earth element activator such as europium. Examples include Sr₂Si₅N₈, BaSi₇N₁₀, and CaSiN₂.

As taught in US 2007/0040152 to S. Oshio, a compound such as CaSiN₂ becomes a CaSiN₂:Eu²⁺ phosphor emitting red light having an emission peak in the vicinity of 630 nm, where the Eu²⁺ ions function as the luminescent centers. The excitation spectrum of the compound has a peak around 370 nm, and although the phosphor does not emit red light when excited by 440 to less than 500 nm excitation radiation, it does emit red light with high intensity when excited by 330 to 420 near ultraviolet light.

US 2007/0040152 also elucidated the difficulties in producing a nitridosilicate based compound such as M₂Si₅N₈, MSi₇N₁₀, and MSiN₂, where M is at least one element selected from Mg, Ca, Sr, and Ba, etc., where the compound contains substantially no oxygen. This may be achieved, it is taught, by using as starting materials the nitrides of the alkaline-earth elements and the rare earth elements, but these nitrides are difficult to obtain, expensive, and difficult to handle. These factors conspire to make nitridosilicate-based phosphors difficult to produce industrially. As stated by the reference: “the conventional nitridosilicate-based compound has the following problems: (1) low purity due to the presence of a large amount of impurity oxygen, (2) low material performance of a phosphor caused by the low purity; (3) high cost; and the like.” The problems include low luminous flux and [low] brightness.

But if the problems inherent in producing nitridosilicate-based phosphors have been explicitly stated, so too have the benefits of a substantially oxygen-free compound. U.S. Pat. No. 7,252,788 to Nagatomi et al. teaches a phosphor having a quaternary host material represented by the general formula M-A-B—N:Z, where M, A, and B are divalent, trivalent, and tetravalent elements, respectively; N is nitrogen, and Z is the activator. As an example, M could be Ca, A aluminum, B silicon, and Z could be Eu, thus forming the compound CaAlSiN₃:Eu²⁺. It is clear from the general formula (and the example) that these phosphors have deliberately excluded oxygen from the constituent elements, and thus these phosphors are in a different class than a conventional phosphor having a sialon group host material (Si—Al—O—N group) and a phosphor having a Si—O—N group host material.

Nagatomi et al. discovered and disclosed in U.S. Pat. No. 7,252,788 that when the oxygen content in the phosphor is large, the emission efficiency decreased (not desirable), and the emission wavelength of the phosphor also tended to shift to a shorter wavelength side. This latter observation is also undesirable because most (if not all) manufacturers are attempting to add a phosphor that is deeper in the red region (i.e., less orange or yellow) for the color rendering benefits a red phosphor offers to the white LED industry. Nagatomi et al. continue: the phosphor they provided includes no oxygen in the host material, with the benefits of exhibiting a higher emission efficiency, and avoiding the shift of the emission wavelength to the shorter wavelength side [of the spectrum].

But this is more easily stated than accomplished. Oxygen contamination was addressed by Nagatomi et al. in US 2006/0017365, where it is taught that the source is believed to be the oxygen adhering to the surface of the raw materials, and thus introduced at the start of the synthesis; oxygen added as a result of oxidation of the surface of the raw materials at the time of preparation for firing, and the actual firing, and the oxygen adsorbed onto the surface of the phosphor particles after firing.

A discussion of oxygen measurements, and an analysis of the possible causes for a discrepancy between measured and calculated values, was also given by Nagatomi et al. in US 2006/0017365. The oxygen content that was measured in their sample was 2.4 percent by weight, to be contrasted with a calculated oxygen concentration of 0.3 percent by weight. The origin of this approximately 2 percent by weight difference between the measured value (with its so-called “excessive oxygen”) versus the calculated amount was attributed to oxygen originally adhering to the surface of the raw materials at the time of preparation of the firing and at the time of firing, and the oxygen adsorbed onto the surface of the phosphor specimen after the firing.

The oxygen content in Nagatomi et al.'s samples of U.S. Pat. No. 7,252,788 similarly show a 2 plus percent by weight value: 2.2, 2.2, and 2.1 in Tables 1 and 3.

Tabling the oxygen discussion for the moment, and turning to a different topic of background, the present inventors have disclosed and patented phosphor compositions having a halogen content, and have enumerated the benefits thereof. Their compositions and synthesis techniques have been used in several types of host crystal lattices, and in phosphors that emit in several regions of the electromagnetic spectrum. For example, an aluminate based, blue emitting phosphor with halogen has been described in Published Application No. US 2006/0027786; a yellow-green emitting silicate-based phosphor with halogen has been described in U.S. Pat. N. 7,311,858, and an orange emitting silicate-based phosphor with halogen has been described in Published Application No. US 2007/0029526. These three examples have been chosen in particular to show that the blue through orange region of the spectrum has been addressed, but what is missing is a phosphor emitting in the red, with the same enhanced attributes including photoluminescent intensity demonstrated by the other members of the series.

The present inventors have shown that halogen inclusion is beneficial in nitridosilicate-based red phosphors, and equally unexpected is that in achieving that goal, the oxygen content was simultaneously reduced to a level below 2 percent by weight, with the attendant advantages outlined above.

### SUMMARY OF THE INVENTION

Embodiments of the present invention are directed to the fluorescence of a nitride-based deep red phosphor having at least one of the following novel features: 1) an oxygen content less than about 2 percent by weight, and 2) a halogen content. Such phosphors are particularly useful in the white light illumination industry, which utilizes the so-called “white LED.” The selection and use of a rare earth halide as a raw material source of not only the activator for the phosphor, but also the halogen, is a key feature of the present embodiments. The present phosphors have the general formula MₐM_{b}B_{c}(N,D)₃:Eu²⁺ where Mₐ is a divalent alkaline earth metal such as Mg, Ca, Sr, Ba; M_{b} is a trivalent metal such as Al, Ga, Bi, Y, La, and Sm; and M_{c} is a tetravalent element such as Si, Ge, P, and B; N is nitrogen, and D is a halogen such as F, Cl, or Br. An exemplary compound is CaAlSi(N₁₋ₓFₓ)₃: Eu²⁺. The present phosphors have a chemically stable structure, and are configured to emit visible light having a peak emission greater than about 620 nm with a high emission efficiency.

### BRIEF DESCRIPTION OF THE DRAWINGS

FIG. 1A is a graph of emission wavelength versus Eu content for two phosphors having the formula Ca₁₋ₓAlSiN₃Euₓ, where EuF₃ as a source of both europium and halogen is being compared to a sample where Eu₂O₃ is the europium source;

FIG. 1B is a graph similar to FIG. 1A in which europium halide and europium oxide as starting materials are compared; this is a graph of photoluminescence versus europium content;

FIG. 1C is an emission spectra of samples of CaAlSiN₃ with different halogen sources: EuF₂, EuF₃, and Eu₂O₃ with a halogen containing flux, showing the superior performance of these halogen-containing nitride phosphors;

FIG. 1D is a normalized emission spectra of samples of CaAlSiN₃ synthesized with different halogen sources: EuF₂, EuF₃, and Eu₂O₃ with a halogen containing flux, normalized to show the shift in wavelength deeper into the red for the present halogen-containing nitride phosphors;

FIG. 2A is a collection of emission spectra showing the effect of doping a phosphor having the composition Ca_{0.93}AlSiM_{0.05}N₃Eu_{0.02}:F, where M is a divalent alkaline earth metal such as Mg, Ca, Sr, and Ba;

FIG. 2B is an emission spectra of the present exemplary phosphors showing the effect of using CaF₂ at different levels as a means to supply the halogen content as well as an alkaline earth metal, CaF₂ substituting for CaN₂ as a raw material;

FIG. 2C is a normalized version of the data from FIG. 2B, plotted in this manner to show the effect of a wavelength shift to longer wavelengths for these halogen containing nitride phosphors;

FIG. 3 is a collection of emission spectra of the present red nitride phosphors wherein AlF₃ has been used as the source of the trivalent element (in this case Al), as well as a source of the halogen; here AlF3 replaces about 5 atomic percent of AlN in the raw materials list;

FIG. 4 is a collection of emission spectra of the present red nitride phosphors wherein (NH₄)₂SiF₆ replaces Si₃N₄ at about 5 atomic percent in the raw material mixture before firing;

FIG. 5A is a collection of two emission spectra showing the effect of using a flux during processing, wherein at least one purpose of the NH₄F flux is to provide a halogen source for the present nitride-based red phosphors;

FIGS. 5B and 5C are also emission spectra that show the effect of flux addition; FIG. 5B for flux with Eu₂O₃ as a source of europium, and FIG. 5C for flux with a halogen-containing europium source;

FIG. 5D is an emission spectra showing the effect of flux addition, this time using chlorine (NH₄Cl) as the halogen source in one case, and fluorine (NH₄F) in the other;

FIGS. 5E-G are graphs showing the effect of a flux (NH₄F) addition on peak emission wavelength position, photoluminescent (PL) intensity, and full width as half maximum (FWHM) of the emission peaks,

FIGS. 5H-I are graphs of the CIE coordinates x and y as a function of flux (NH₄F) addition, when the oxide of europium is used as the activator (europium) source;

FIGS. 5J-K show tabulated version of the CIE data for the present nitride phosphors with and without flux, using oxide and halide compounds as europium sources;

FIGS. 6A-C are tabulations of the oxygen, fluorine, and chlorine content of the present red phosphors, the respective contents measured by EDS;

FIG. 7 is a comparison of chlorine versus fluorine as the halogen in emission spectra of the present red nitrides;

FIG. 8 is an x-ray diffraction pattern of an exemplary compound of the form CaAlSi(F,N)₃:Eu²⁺, demonstrating that these novel compounds are substantially oxygen-free; this particular compound had the formula Ca_{0.98}AlSiN₃Eu_{0.02}:F;

FIGS. 9A-C are excitation spectra for the present nitride-based red phosphors, where FIG. 9A shows that the phosphors are efficient at fluorescing when excited at radiation wavelengths ranging from about 300 to 610 nm; FIG. 9B shows excitation spectra for phosphors having different levels of europium content; and FIG. 9C is an excitation spectra of the nitride Ca_{0.97}AlSiN₃Eu_{0.003}Fₓ, where different levels of flux have been used; and

FIGS. 10A-D are emission spectra demonstrating the advantages of using the present red phosphors in white light illumination systems, where a higher CRI and warm-white lighting source have been realized.

### DETAILED DESCRIPTION OF THE INVENTION

Embodiments of the present invention are directed to the fluorescence of a nitride-based deep-red phosphor having at least one of the following novel features: 1) an oxygen content less than about 2 percent by weight, and 2) a halogen content of virtually any amount. Such phosphors are particularly useful in the white light illumination industry, which utilizes the so-called “white LED.” The selection and use of a rare earth halide as a raw material source of not only the rare earth activator for the phosphor, but also the halogen, is a key feature of the present embodiments. While not wishing to be bound by any particular theory, it is believed the halogen may play a dual role in enhancing the properties of these phosphors: by reducing the oxygen content in addition to causing an increase in photoluminescent intensity and spectral emission.

### Formula Descriptions of the Present Phosphors

There are several ways to describe the formula of the present phosphors. In one embodiment, the present phosphors have the form M-A-B—(N,D):Z, where M, A, and B are three cationic metals and/or semimetals with divalent, trivalent, and tetravalent valences, respectively; N is nitrogen (a trivalent element), and D is a monovalent halogen that along with the nitrogen contributes to the anionic charge balance. Thus, these compounds may be thought of as halogen-containing nitrides. The element Z is an activator in the host crystal, providing the photoluminescent centers. Z may be a rare earth or transition metal element.

The present nitride-based red phosphors may be described in a slightly different format, to emphasize the approximate ratios of the constituent elements. This formula takes the form MₘMₐM_{b}(N,D)ₙ:Z_{z}, where the stoichiometry of the constituent elements (m+z):a:b:n follows the general ratios 1:1:1:3, although deviations from these integer values are contemplated. It is noted the formula shows that the activator Z substitutes for the divalent metal Mₘ in the host crystal, and that the host material of the phosphor contains substantially no oxygen (or at least, less than about 2 percent by weight).

The present nitride-based red phosphors may be described in yet another manner, this format emphasizing the stiochiometric relationship between the amounts of the metals and halogen(s) present relative to the amount of nitrogen present in the nitride host. This representation has the form MₘMₐM_{b}D_{3w}N_{[(2/3)(m+z)+a+(4/3)b-w]}Z_{z}. The parameters m, a, b, w, and z fall within the following ranges: 0.01≦m≦1.5; 0.01≦a≦1.5; 0.01≦b1.5; 0.0001≦w≦0.6, and 0.0001≦m≦0.5.

The metal Mₘ may be an alkaline earth or otherwise divalent metal such as Be, Mg, Ca, Sr, Ba, Zn, Cd, and/or Hg. Different combinations are possible, and Mₘ may be a single one of these elements, or a mixture of any or all of them. In one embodiment, the metal Mₘ is Ca.

Mₐ is a trivalent metal (or semimetal) such as B, Al, Ga, In, Y, Sc, P, As, La, Sm, Sb, and Bi. Again, different combinations and contents of these metals/semimetals are possible, and in one embodiment, the metal Mₐ is Al.

M_{b} is a tetravalent element such as C, Si, Ge, Sn, Ni, Hf, Mo, W, Cr, Pb, Ti, and Zr. In one embodiment, the tetravalent element M_{b} is Si.

The element D is a halogen such as F, Cl, or Br in this nitride-based compound, and may be contained within the crystal in any of a number of configurations: for example, it may be present in a substitutional role (substituting for nitrogen) in the crystalline host; it may be present interstitially in the crystal, and/or perhaps within grain boundaries that separate crystalline grains, regions, and/or phases.

Z is an activator comprising at least one or more of the rare earth elements and/or transition metal elements, and include Eu, Ce, Mn, Tb, and Sm. In one embodiment the activator Z is europium. According to one embodiment of the present invention the activator is divalent, and substitutes for the divalent metal Mₘ in the crystal. The relative amounts of the activator and the divalent metal Mₘ may be described by the molar relationship z/(m+z), which falls within the range of about 0.0001 to about 0.5. Keeping the amount of the activator within this range may substantially avoid the so-called quenching effect manifested by a decrease in emission intensity caused by an excessive concentration of the activator. The desired amount of the activator may change with the particular choice of activator.

An exemplary compound according to the present embodiments is CaAlSi(N₁₋ₓFₓ)₃: Eu²⁺. Other halogens including chlorine may be used instead of the fluorine, or in combination with the fluorine. This compound emits in the deep-red region of the spectrum with a photoluminescent intensity greater than that demonstrated by the nitrides of the prior art, where the amount of halogen inclusion influences the degree to which the peak emission wavelength shift toward longer wavelengths (deeper into the red).

### Starting Materials

Prior art starting materials have typically consisted of the nitrides and oxides of the metals. For example, to produce the phosphor CaAlSiN₃:Eu²⁺ in U.S. Pat. No. 7,252,788, it is taught that the nitride starting materials for the calcium, aluminum, and silicon sources may be Ca₃N₂, AlN, and Si₃N₄, respectively. The source of the europium in this disclosure was the oxide Eu₂O₃. In contrast, the sources of the metals in the present phosphors may be at least in part the halides of the metals, and typical examples include MgF, CaF, SrF, BaF, AlF, GaF, BF, InF, and (NH₄)₂SiF₆. The europium may be supplied by either of the two fluorides EuF₂ and EuF₃. The use of halides of the divalent, trivalent, and tetravalent metals is not the only way to supply the halogen to the phosphor: an alternative method is to use a flux such as NH₄F or LiF.

Specifically, compounds of the divalent metal Mₘ appropriate as raw materials in the synthesis of the present phosphors include nitrides, oxides, and halides; e.g., Mm₃N₂, MmO, MmD₂, where again D is F, Cl, Br, and/or I. Analogous raw material compounds of the trivalent metal Mₐ are MaN, Ma₂O₃, and MaD₃. The tetravalent metal starting compounds include Mb₃N₄, and (NH₄)₂MbF₆. Compounds of the halide anion D include NH₄D and AeD, where Ae is an alkaline metal such as Li, Na, and MD₂, where Me is an alkaline earth metal such as Mg, Ca, etc.

Prior art references have disclosed the oxide of europium, Eu₂O₃, as the source of the europium activator, as this material is a readily available commercial compound. The present inventors have discovered, however, that the oxygen in this compound has a deleterious effect on the photoluminescent properties of the phosphor. One way of eliminating this problem is to use a europium source that does not contain oxygen, such as the substantially pure Eu metal, but this is a very expensive approach that is difficult to implement. One embodiment of the present invention is to use a Eu halide, such as EuF₃ and/or EuCl₃ as europium-containing starting materials. The present inventors have found that when a europium halide such as EuF₃ is used as the europium source, the emission efficiency of the phosphor increases, and the emission wavelength of the phosphor shifts to a longer wavelength. Thus one embodiment of the present invention is to use a europium compound EuD₃(D=F, Cl, Br, I), and not Eu₂O₃, as the europium source. These concepts will be illustrated, and discussed more fully, in conjunction with the accompanying figures.

### Emission Intensities and Wavelengths as A Function of Starting Materials

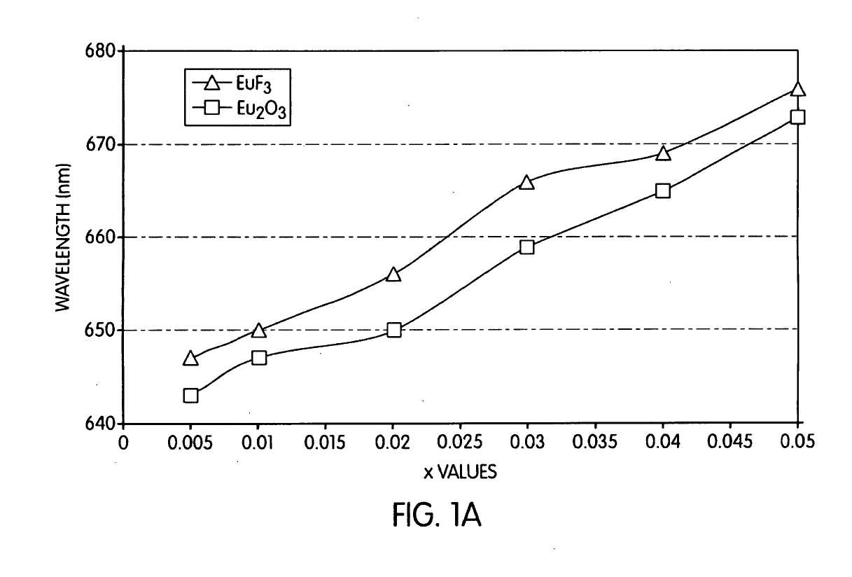

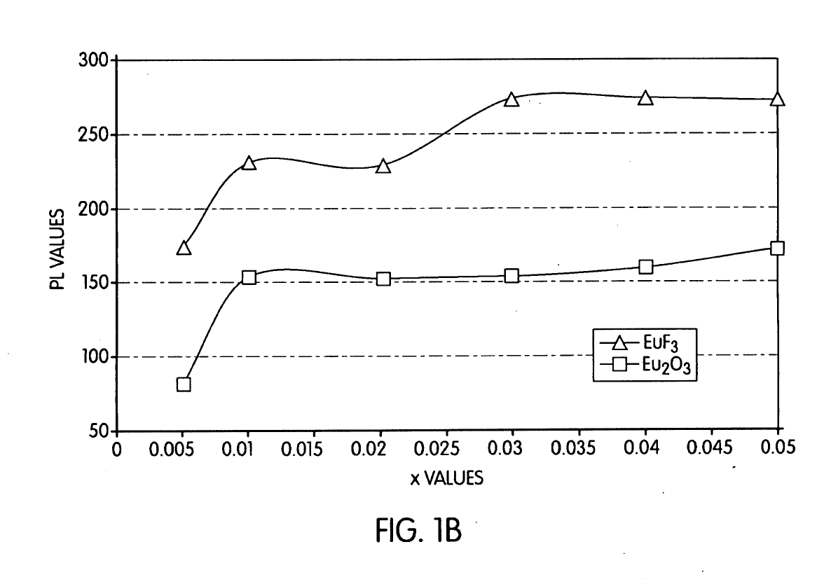

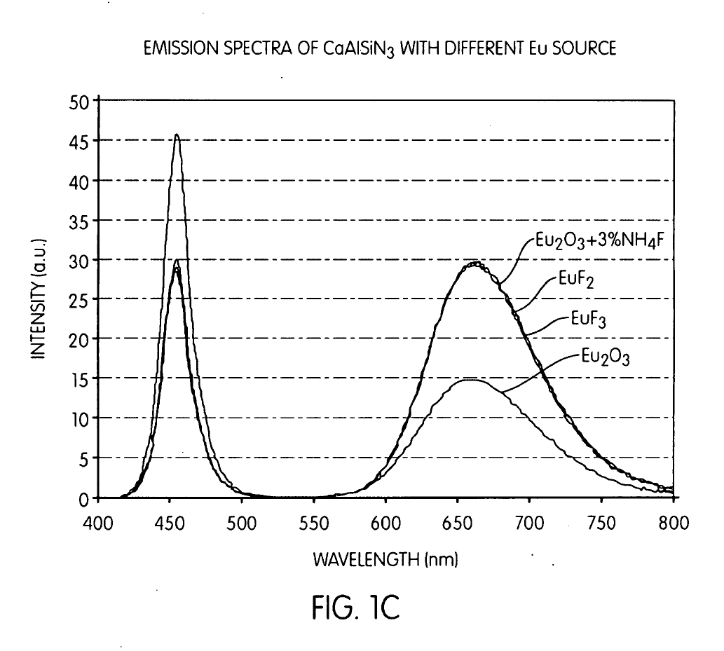

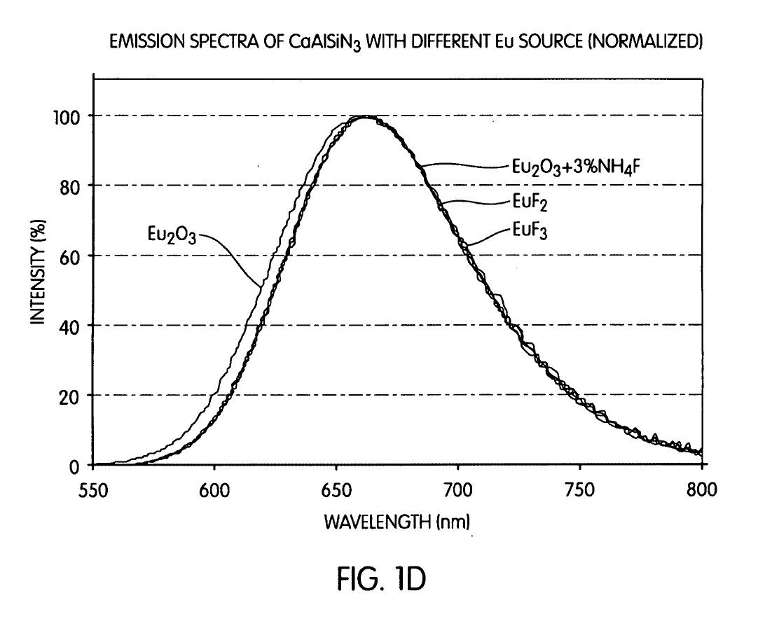

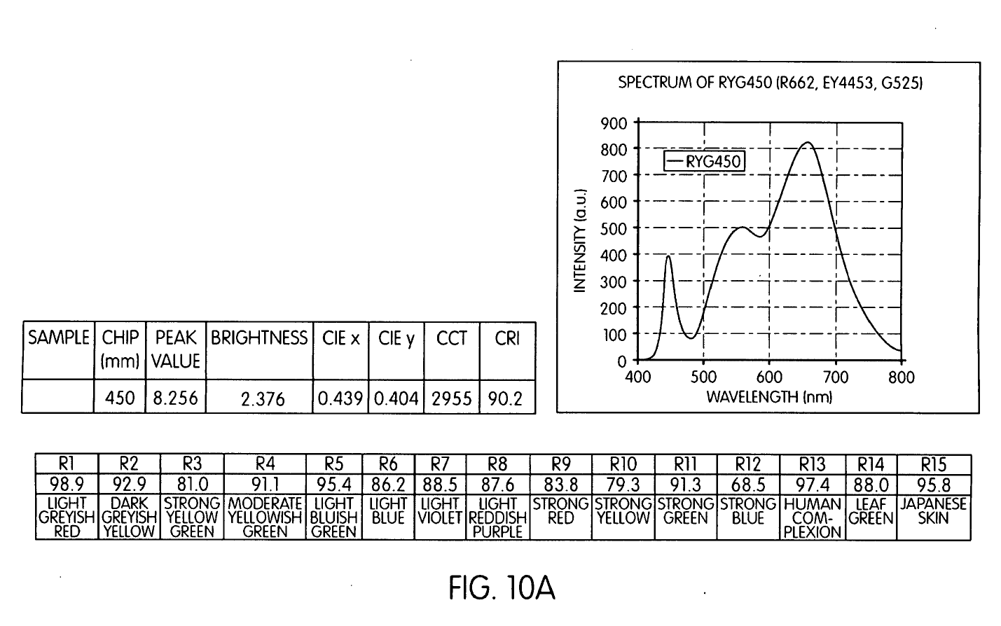

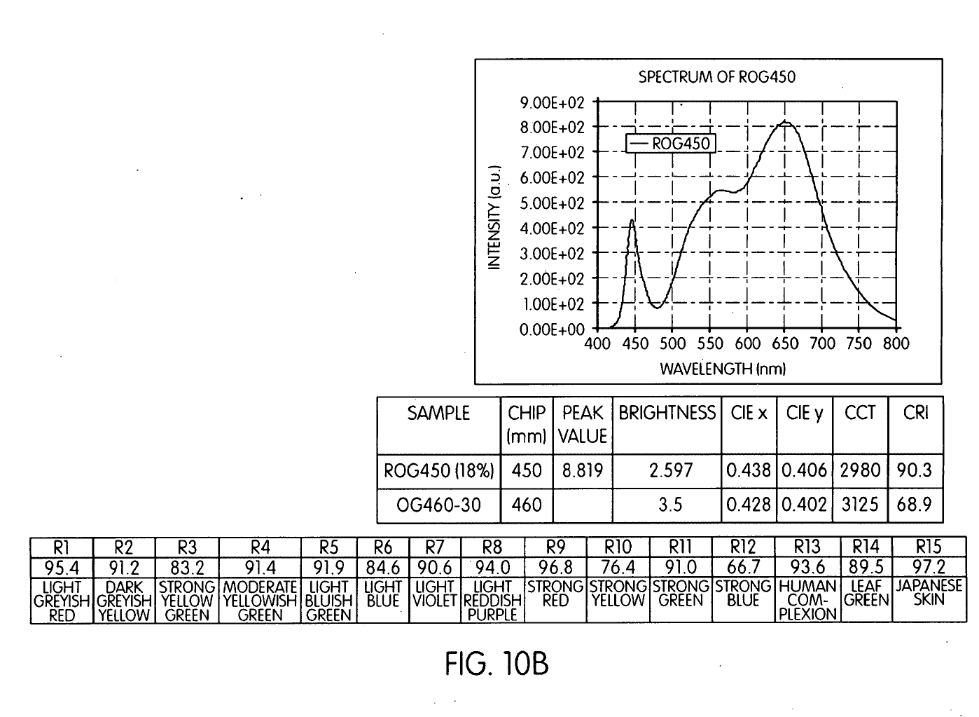

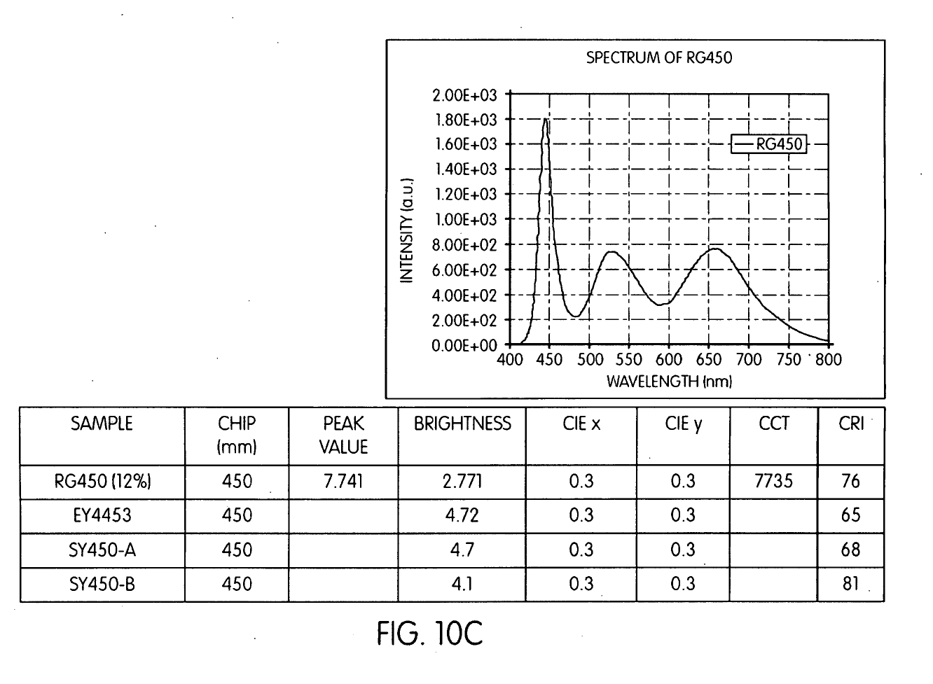

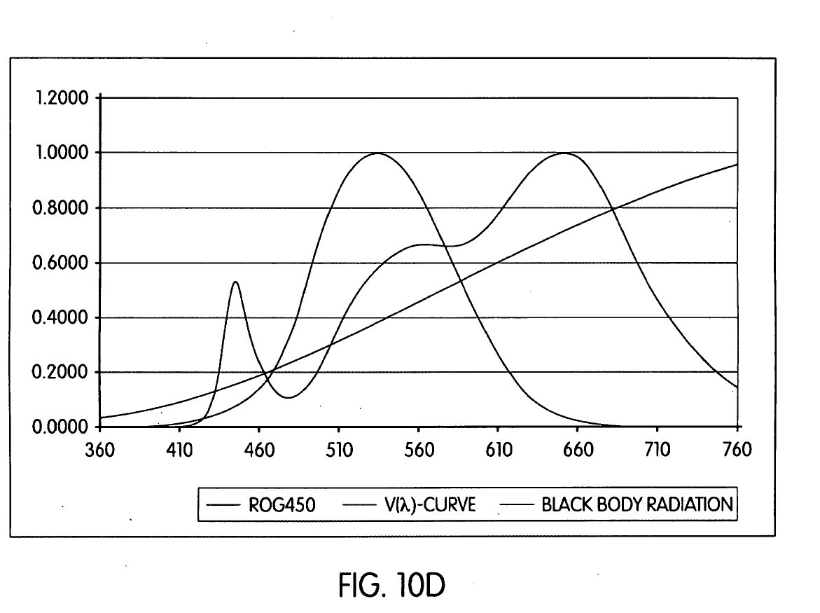

FIG. 1A is a graph comparing the peak emission wavelength of samples of a compound having the general formula Ca₁₋ₓAlSiN₃Euₓ, where peak emission wavelength is plotted as a function of the amount of europium for two different samples. One sample was synthesized using EuF₃ as the source of the europium; the other had Eu₂O₃ as the source. As the europium content “x” was increased from 0.005 to 0.05 the wavelength of the peak emission increased generally from between about 640 to 650 nm to between about 670 to 680 nm, but in all cases, the samples made with EuF₃ as the source of the europium emitted at longer wavelengths than their counterpart samples made with Eu₂O₃. This is demonstrated in FIG. 10A by the curve with the triangles being higher than the curve with the squares. In other words, inclusion of F in the phosphor shifts the emission to longer wavelengths, and this increase in deeper red emission is beneficial to the white LED industry. Referring again to FIG. 1A, it may be observed that the EuF₃ generated samples emit at about 5 nm longer in wavelength then their Eu₂O₃ based counterparts, and this is evidence that the halogen is being incorporated into the crystal in positions adjacent to the europium activator.

Not only do the EuF₃ generated samples emit at longer wavelengths than Eu₂O₃ based samples having the same europium content, but the EuF₃ generated samples are brighter as well. This is illustrated in FIG. 1B. Here again, the europium content was increased from x=0.005 to 0.05. Both curves show an increase in emission intensity as x is increased from 0.005 to 0.01, but whereas the Eu₂O₃ based samples display about the same pholuminescent intensity as the europium content is increased further after x=0.01, the EuF₃ generated samples have another jump in intensity (of about 20 percent) as x was increased from 0.02 to 0.03. In general, the intensity of the samples made with EuF₃ was about 60 to 70 percent brighter than the samples made with Eu₂O₃. While it is not precisely known whether this is due to the inclusion of halogen or absence of oxygen (by a halogen-instigated oxygen gettering effect), it is recognized that either way, the effect is advantageous.

Data from an experiment comparing the optical properties of CaAlSiN₃ type samples made with 1) Eu₂O₃, 2) EuF₂, 3) EuF₃, and 4) Eu₂O₃ with a 3% NH₄F flux is shown in FIGS. 1C and 1D. Peak emission intensity as a function of peak emission wavelength is shown in FIG. 1C, where there is a striking difference in intensity between the sample with no halogen, the Eu₂O₃ based sample, and the three samples that have had halogen introduced one way or another, the EuF₂, EuF₃, and Eu₂O₃ with a 3% NH₄F flux based samples. The latter three curves substantially overlay one another. FIG. 1C shows that there is a 50 percent increase in peak emission intensity when a halogen is introduced into the phosphor(s). Furthermore, it doesn't seem to matter particularly whether the halogen is supplied in the starting materials as a salt of the europium source, as in the case of the divalent and trivalent sources EuF₂, EuF₃, respectively, or as part of a halogen containing flux where the europium source is an oxide of the activator. The point of re-plotting the data from FIG. 1C in the normalized fashion of FIG. 1D (normalized by photoluminescent intensity) is again to emphasize the physics of halogen inclusion: that all three of the fluorine containing samples emit at longer wavelengths than the Eu₂O₃ based sample. This is a strong indication that the halogen has been incorporated into the host lattice of the phosphor.

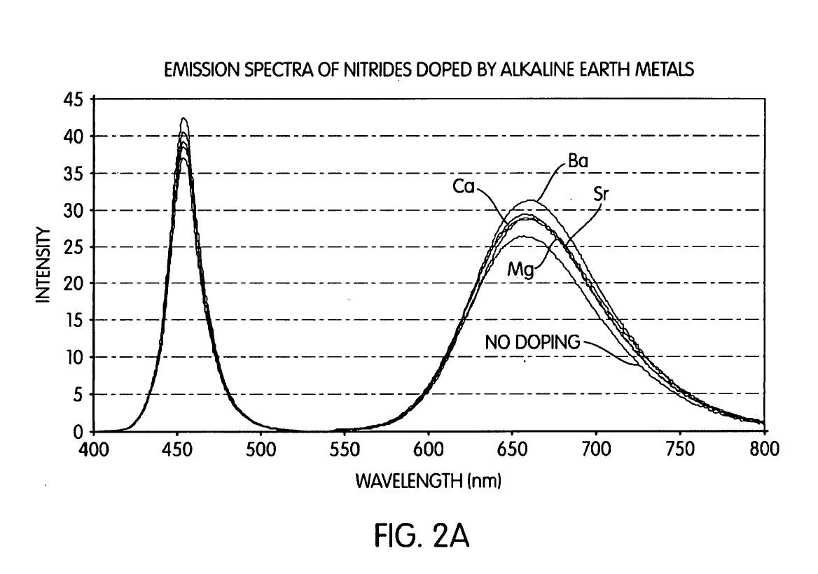

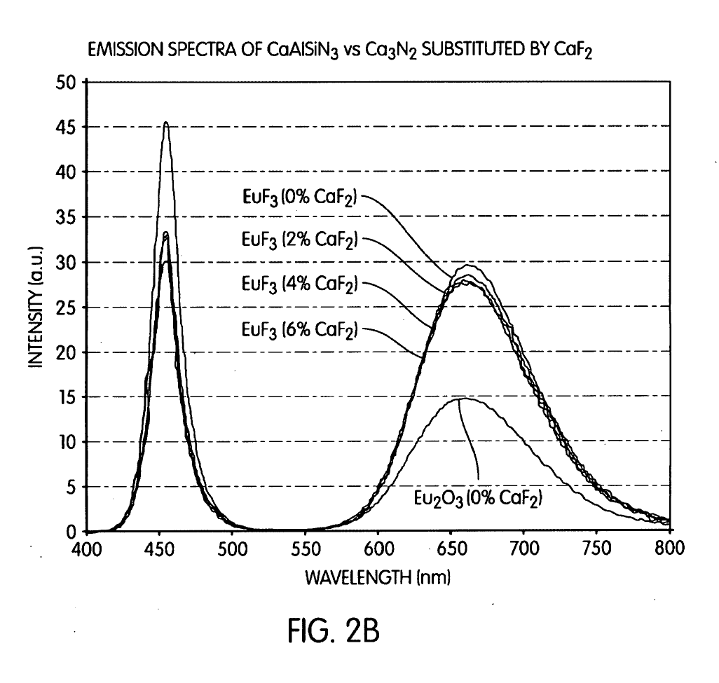

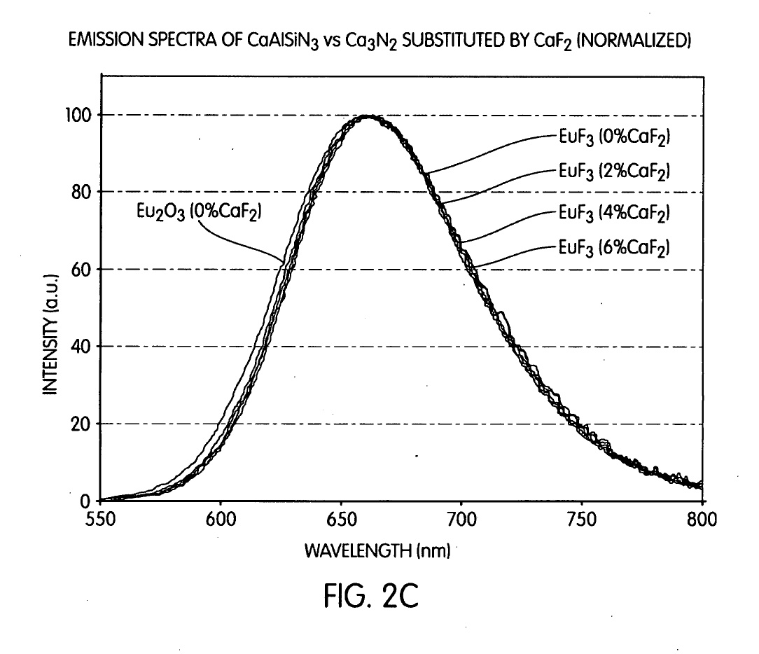

The effect of doping the present nitrides with alkaline earth metals is investigated in FIGS. 2A-2C. The format of FIG. 2A is of a similar to that of FIG. 1A, a plot of emission intensity versus peak emission wavelength, this time for a collection of samples having the formula Ca_{0.93}AlSiM_{0.05}N₃Eu_{0.02}:F, where M is Mg, Ca, Sr, and Ba, and where one sample is a control having no M doping. The europium source for each of the samples in FIG. 2A was EuF₃. This set of data shows that the order of highest to lowest intensity is Ba, Ca, Sr, Mg doping, with the sample having no alkaline earth doping the lowest intensity. In addition to decreasing intensity, the order of longest wavelength to shortest peak emission wavelength was Ba, Ca, Sr, Mg doping to no doping.

The halogen may be introduced as a salt of the alkaline earth metal component. This data is shown in FIGS. 2B-2C. Using CaF₂ as a raw material substituting for part of Ca₃N₂ as a raw material, and with the europium concentration fixed at 2 atomic percent, the order of photoluminescent intensity was 0 to 2, 4, and 6 percent CaF₂ in the raw materials when the europium source was EuF₃, although there was not much difference among these samples. There was, however, about a 50 percent decrease in emission intensity between this group of phosphors and a phosphor made from Eu₂O₃ as the europium source, and no CaF₂. This data is shown in FIG. 2B. Essentially the same data is shown in FIG. 2C but this time normalized with respect to intensity, again to show that the shortest wavelength sample had no fluorine.

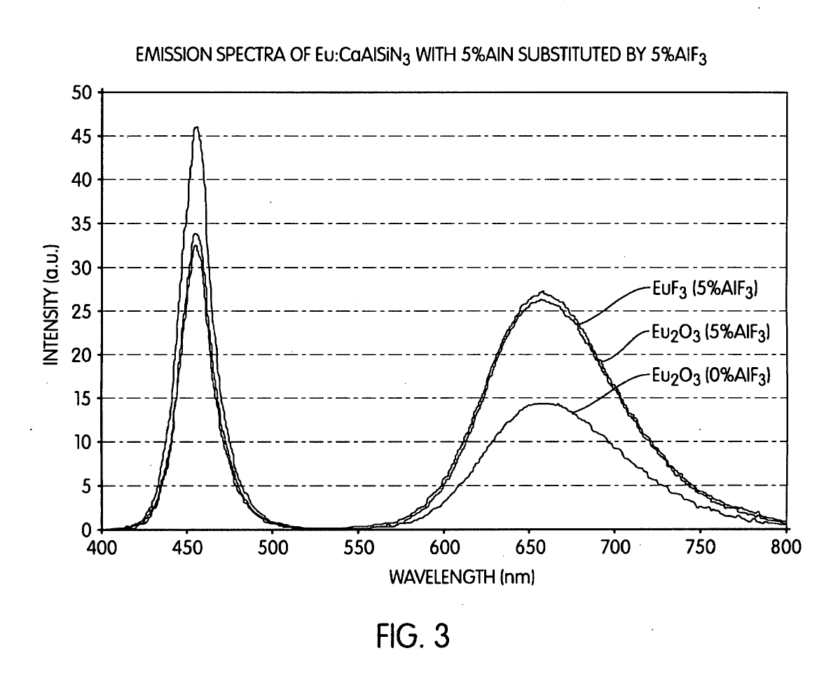

Alternatively, the halogen may be introduced as a salt of the trivalent component, which may be the transition metal element aluminum. Use of AlF₃ as a raw material substituting for AlN at a 5 atomic percent level in a CaAlSiN₃:Eu²⁺ type phosphor is shown in FIG. 3. The europium concentration was again fixed at 2 atomic percent, and phosphors were made with: 1) EuF₃ with 5 atomic percent AlF₃, 2) Eu₂O₃ with 5 percent AlF₃, and 3) Eu₂O₃ with no AlF₃. The photolumescent intensity of phosphors having 5 atomic percent AlF₃ as starting materials, whether the europium source was halogenated or not, was about 40 percent greater than the phosphor having no halogen content, i.e., the phosphor made with Eu₂O₃ with no AlF₃. In other words, the source of the halogen didn't seem to matter particularly; it could be provided as a halogenated salt of either the europium or trivalent aluminum in this CaAlSiN₃:Eu phosphor, and photoluminescent intensity was enhanced significantly with the halogen.

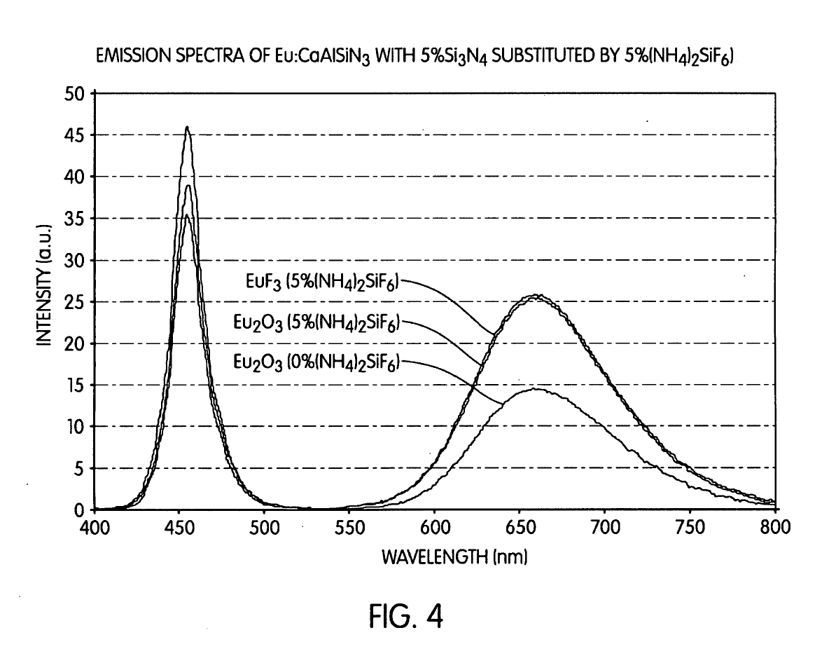

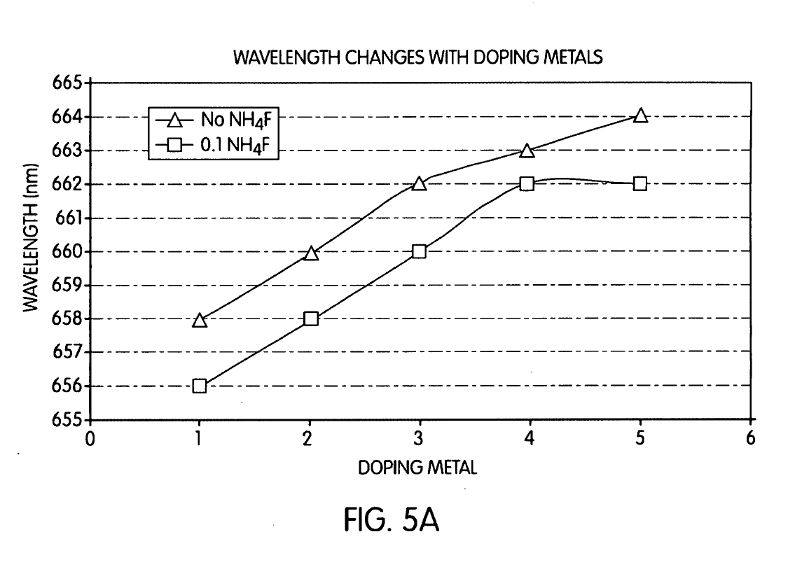

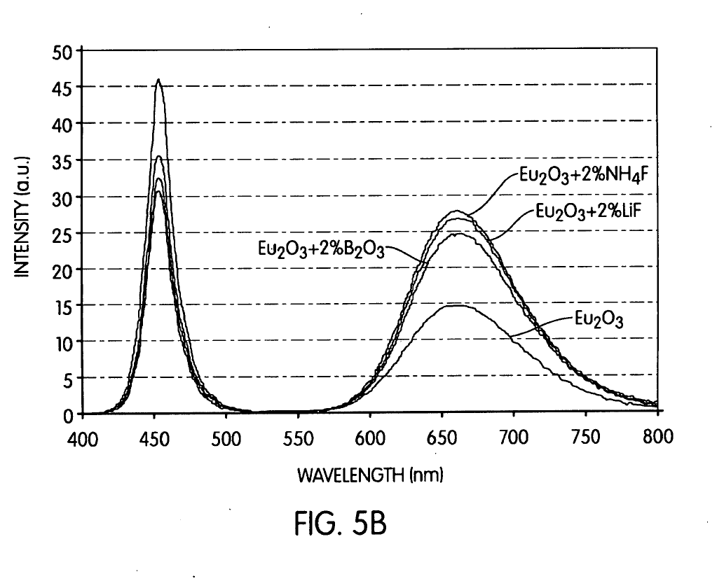

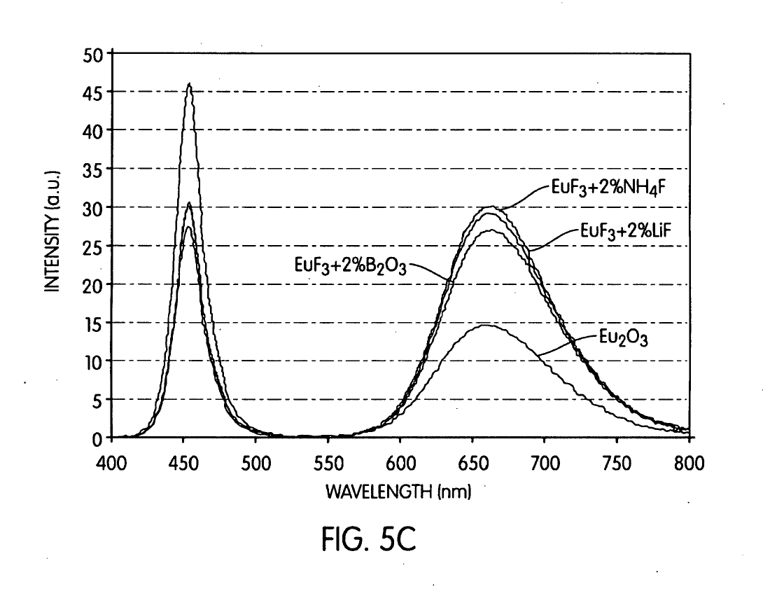

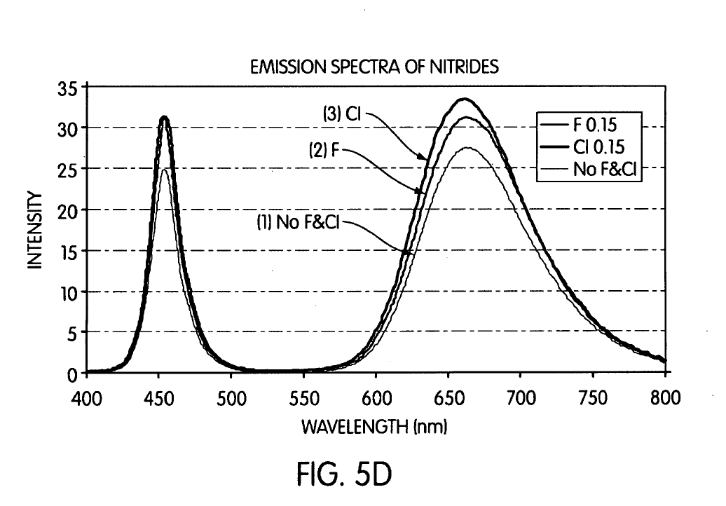

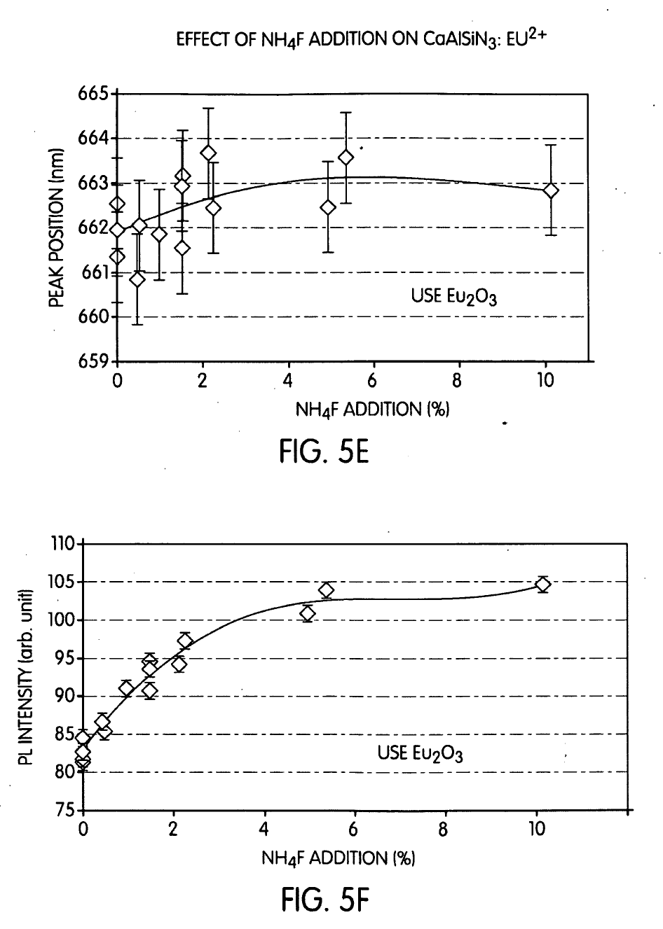

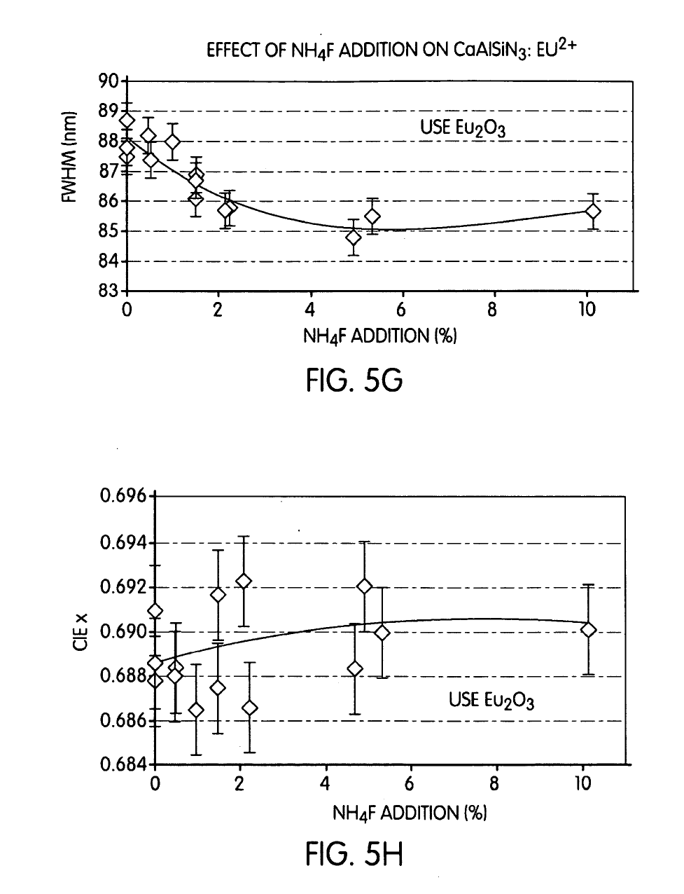

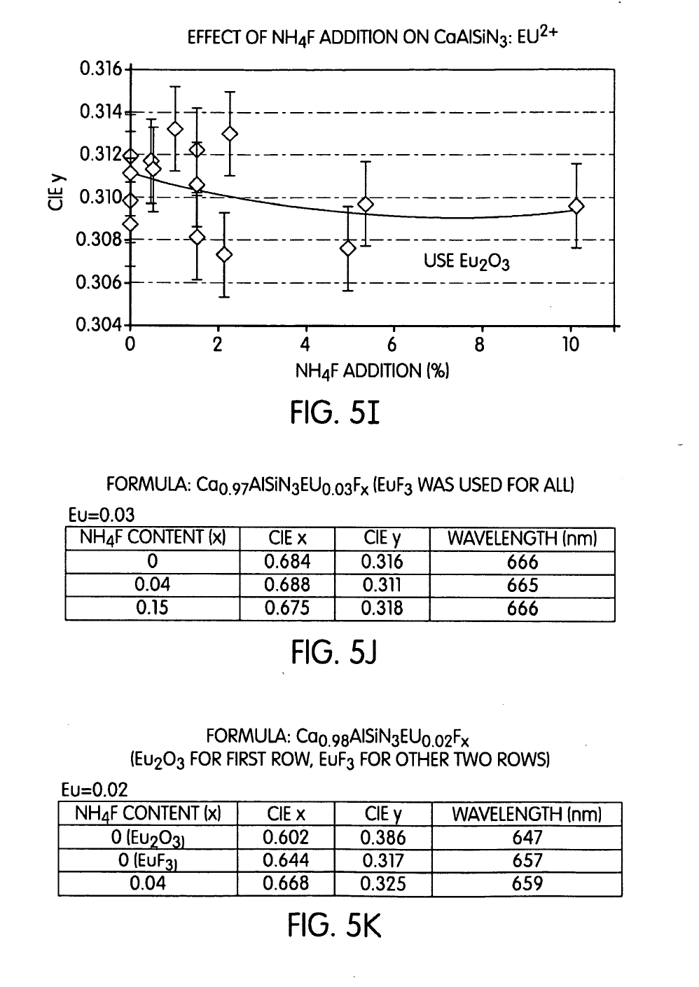

Alternatively, the halogen may be introduced as a salt of the tetravalent metal, semi-metal, or semiconducting element, which may be silicon. An experiment similar to the FIG. 4 experiment was carried out in which either the silicon containing starting material or the europium was used to provide the halogen: these results are shown in FIG. 5. The europium concentration was again fixed at 2 atomic percent, and phosphors made with: 1) EuF₃ with 5 atomic percent (NH₄)₂SiF₆, 2) Eu₂O₃ with 5 percent (NH₄)₂SiF₆, and 3) Eu₂O₃ with no (NH₄)₂SiF₆ were compared. The photolumescent intensity of phosphors having 5 atomic percent (NH₄)₂SiF₆ as starting materials, whether the europium source was halogenated or not, was again about 40 percent greater than the phosphor having no halogen content, i.e., the phosphor made with Eu₂O₃ with no (NH₄)₂SiF₆. Here again the source of the halogen didn't seem to matter particularly; it could be provided as a halogenated salt of either the europium or tetravalent silicon in this CaAlSiN₃:Eu²⁺ phosphor, and photoluminescent intensity was enhanced significantly with the halogen.

The halogen may also be supplied in the form of a flux for these nitride-based red phosphors. The effect of adding an NH₄F flux to the starting materials is investigated in FIGS. 5A-G. The first of this series, FIG. 5A, shows peak emission wavelengths from each of the alkaline earth doping metals Mg, Ca, Sr, and Ba, similar to the data shown earlier in FIG. 2A, but here in FIG. 5A one set with a 0.1 mol NH₄F flux content (squares), and the other (triangles) with no flux. For each set with and without flux the samples 1-5 on the x-axis (labeled “doping metal”) are, respectively, 1) Ca_{0.98}AlSiN₃Eu_{0.02}:F, 2) Ca_{0.98}AlSiN₃Mg_{0.05}Eu_{0.02}:F, 3) Ca_{0.98}AlSiN₃Ca_{0.05}Eu_{0.02}:F, 4) Ca_{0.98}AlSiN₃Sr_{0.05}Eu_{0.02}:f, and 5) Ca_{0.98}AlSiN₃Ba_{0.05}Eu_{0.02}:F. A fluorinated europium compound, EuF₃ was used as the europium source. As in FIG. 2A the data shows that peak emission wavelength shifted to longer wavelengths as the alkaline earth doping metal was changed in the order Mg, Ca, Sr, and Ba. But this data shows that the wavelengths of the samples without flux was actually about 2 nm longer than those corresponding samples with flux. This seems to say that if longer wavelengths are desired, it may be preferable to supply the halogen as a salt of the alkaline earth metal in the starting materials, and not as an NH₄⁺-halogen based flux.

Fluxes other than NH₄F may be used, of course, such as LiF and B₂O₃. LiF and B₂O₃ were compared to NH₄F, each at 2 atomic percent in FIGS. 5B-5C. In FIG. 5B, phosphors made with Eu₂O₃ and 2 atomic percent NH₄F, LiF, and B₂O₃ were compared to a phosphor made with Eu₂O₃ having no flux: the first two samples with their respective fluxes demonstrated about a 40 percent increase in emission intensity compared to the Eu₂O₃ sample with no flux. The sample with the B₂O₃ flux was lower in photoluminescent intensity. A similar experiment was carried out in FIG. 5C except that the two samples with flux were made with a halogenated europium source: 1) EuF₃ with 2 atomic percent NH₄F, 2) EuF₃ with 2 atomic percent LiF, and a third sample with boron: 3) EuF₃ with 2 atomic percent B₂O₃, again compared with a sample made with europium oxide and no flux (i.e., no halogen at all). Here in FIG. 5C, the halogenated samples demonstrated a 40 to 50 percent enhancement in photoluminescent intensity.

But does the nature of the halogen in the flux matter? In other words, what is the effectiveness of a chlorinated flux versus a fluorinated flux? This question was investigated in FIG. 5D, where sample 1) contained neither NH₄Cl nor NH₄F; sample 2) was a phosphor having the formula Ca_{0.97}AlSiN₃Eu_{0.03}:F made with EuF₃ and 0.15 moles of an NH₄F flux; and sample 3) was the same phosphor Ca_{0.97}AlSiN₃Eu_{0.03}:F made again with EuF₃ but this time with 0.15 moles of an NH₄Cl flux. Here in FIG. 5D the intensities of all three samples were bright (because of the halogen originating from the europium salt), but the sample with the chlorine containing flux was brighter than the fluorine containing flux.

The effect of NH₄F addition to a CaAlSiN₃:Eu²⁺ phosphor made with Eu₂O₃, in other words, a non-halogenated red nitride phosphor because the europium source was an oxide rather than a salt of a halogen, is shown in FIGS. 5E-G. FIG. 5E is a graph of peak wavelength position as a function of NH₄F added (from zero to about 10 percent), and the data shows that peak position increases slightly, from about 661 nm to about 663 nm, as the amount of flux added is increased. FIG. 5F is a graph of photoluminescent intensity as a function of the amount of flux added; here, the intensity increases by about 20 percent as the flux is increased from none to 4 percent, but intensity stays relatively constant with further increases in flux content. FIG. 5G is a graph of full width at half maximum (FWHM) of the emission peak, and interestingly, the peaks become more narrow (less broad) as flux is increased from none to about 5 percent. This is most likely saying that the flux has an effect on crystallization, and perhaps grain size distributions.

The effect of an NH₄F flux addition on the CIE x and y values of the luminescence are shown in FIGS. 5H and 5I, with values tabulated in FIGS. 5J-5K; more will be said about CIE and the present phosphors in combination with other phosphors in a later section of this disclosure. In FIG. 5J the formula of the phosphor was Ca_{0.97}AlSiN₃Eu_{0.03}Fₓ with x equal to 0, 0.04, and 0.15. In FIG. 5K the formula of the phosphor was Ca_{0.98}AlSiN₃Eu_{0.02}Fₓ with x equal to 0 and 0.15.

Phosphor Synthesis Processes (with Emphasis on Oxygen Elimination)

The present phosphor synthesis processes will be described using the exemplary compound CaAlSi(N,F)₃:Eu²⁺. The raw materials are weighed and mixed according to the stoichiometric ratios needed to produce the desired phosphor. Nitrides of the elements Mm, Ma, and Mb are commercially available as raw materials. Halides of the divalent metal Mm, and various ammonium halide fluxes, are also commercially available. Raw material sources of europium include its oxide, but this is a viable option primarily when a halogen containing flux is also used. The mixing may be performed using any general mixing method of which typical ones are mortar or ball mill.

In a specific example, the particular raw materials are Ca₃N₂, AlN, Si₃N₄, and EuF₂. In this example, the europium fluoride is being used specifically as a replacement for the traditionally used europium oxide, to utilize the benefits of a reduced oxygen content. One embodiment further reduces the oxygen content by weighing and mixing the raw materials in a glove box under an inert atmosphere, which may comprise nitrogen or argon.

The raw materials are thoroughly blended, and the mixture then heated in an inert atmosphere to a temperature of about 1400° C. to 1600° C. In one embodiment, a heating rate of about 10° C. per minute is used, and maintained at this temperature for about 2 to 10 hours. The product of this sintering reaction is cooled to room temperature, and pulverized using any number of means known in the art, such as a motar, ball mill, and the like, to make a powder with the desired composition.

Similar production methods may be used to phosphors where Mm, Ma, and Mb are other than Ca, Al, and Si, respectively. In this case, compounding amounts of the constituent raw materials may vary.

The present inventors have shown that by using europium halide instead of europium oxide, the oxygen content in the phosphor product may be reduced to less than 2 percent by weight. In a specific example, substituting the halide for the oxide resulted in an oxygen reduction of from about 4.2 percent to about 0.9 percent. In one study performed by the present inventors, the residual 0.9 percent was attributed to the act of weighing and mixing the raw materials in air, rather than in an inert atmosphere.

In air, Ca₃N₂ decomposes to give ammonia and calcium hydroxide:

Ca₃N₂+6H₂O→3Ca(OH)₂+2NH₃,

and ammonia has been observed escaping from the raw material mixture when the starting materials were mixed in air. The surface of the mixture gradually becomes white when the raw materials are kept in air for a period of time, even if only a few minutes. Thus, it is necessary to innovate procedures in which oxygen is deliberately excluded and/or removed from the reaction system. The following procedure has been implemented by the present inventors.

The raw materials Ca₃N₂, AlN, Si₃N₄, and EuF₂ are sealed within an inert atmosphere such as nitrogen and/or argon, and maintained in such a state using a glove box. The raw materials are then weighed within the inert atmosphere, usually in a glove box, and then mixed using ordinary methods known in the art, including mixing with either a mortar or ball mill. The resulting mixture is placed in a crucible, which is then transferred to a tube furnace connected directly to the glove box. This is so that exposure of the mixed raw materials to an inert atmosphere is maintained. In the tube furnace, the mixed raw materials are heated to a temperature of about 1400° C.-1600° C. using a heating rate of about 10° C. per minute, and maintained at that temperature for a time anywhere from about 2 to 10 hours. The sintered product is cooled to room temperature, and pulverized using known methods, including mortar, ball mill, and the like, to produce a powder with the desired composition.

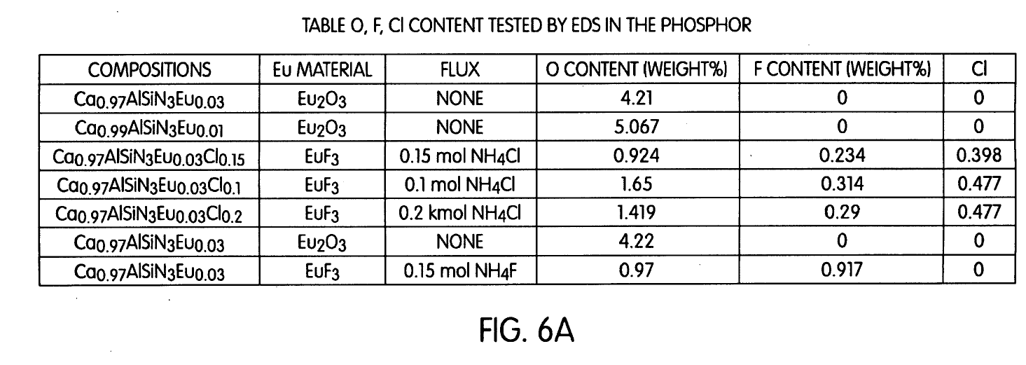

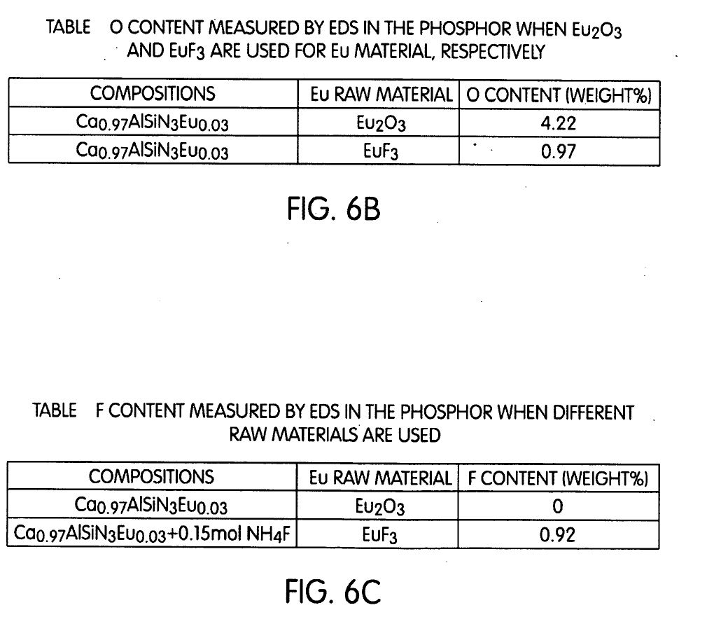

The oxygen, fluorine, and chlorine contents of about 7 exemplary phosphors was measured by EDS, and the results are shown in FIG. 6A to 6C. Energy dispersive x-ray spectroscopy (EDS) is a chemical microanalysis technique performed in conjunction with a scanning electron microscope (SEM). Oxygen, fluorine, and chlorine contents in this disclosure were measured using model EDS2008 from IXRF systems, Inc, and the SEM was model 6330F from JOEL USA INC. This EDS design enables analysis of elements heavier than carbon. The sensitivity of the instrument was 0.1 wt %, where “sensitivity” means the ability to detect the presence of an element above background noise. Thus light elements (low atomic weight) in a heavy matrix may be measured.

In FIG. 6A, the samples showing the highest oxygen contents were Ca_{0.97}AlSiN₃Eu_{0.03}, Ca_{0.99}AlSiN₃Eu_{0.01} and Ca_{0.97}AlSiN₃Eu_{0.03}, each made with europium oxide (Eu₂O₃) as the source of europium in the starting materials. These samples demonstrated an oxygen content of 4.21, 5.067, and 4.22 weight percent, respectively. In contrast, the oxygen contents of three phosphors made with EuF₃ as the europium source, and with a chlorine containing flux was less than about 2 percent by weight. These samples were Ca_{0.97}AlSiN₃Eu_{0.03}Cl_{0.15}, Ca_{0.97}AlSiN₃Eu_{0.03}Cl_{0.1}, and Ca_{0.97}AlSiN₃Eu_{0.03}Cl_{0.2}, and their oxygen contents were 0.924, 1.65, and 1.419 percent by weight, respectively. A fluorinated phosphor made with EuF₃ as the europium source and NH₄F as the flux was Ca_{0.97}AlSiN₃Eu_{0.03}, which showed an oxygen content of 0.97. Thus it was possible to synthesize the present red phosphors with oxygen contents even less than about 1 percent by weight.

The apparent ability (or evidence for the possibility) of a halogen in the europium salt to getter oxygen during the synthesis is shown in FIG. 6B. Here, a sample of Ca_{0.97}AlSiN₃Eu_{0.03} was made in one case with Eu₂O₃ as the europium source; here, the oxygen content was 4.22 weight percent. In contrast, when a phosphor having substantially the same stoichiometric formula was made with EuF₃ as the europium source, the oxygen content was significantly reduced at 0.97 weight percent.

That a halogen may be incorporated into the host lattice of the present nitride-based red phosphors by either a halogen containing flux or halogen containing europium source is shown by the data in FIG. 6C, where a fluorine content of about 0.92 weight percent was found by EDS.

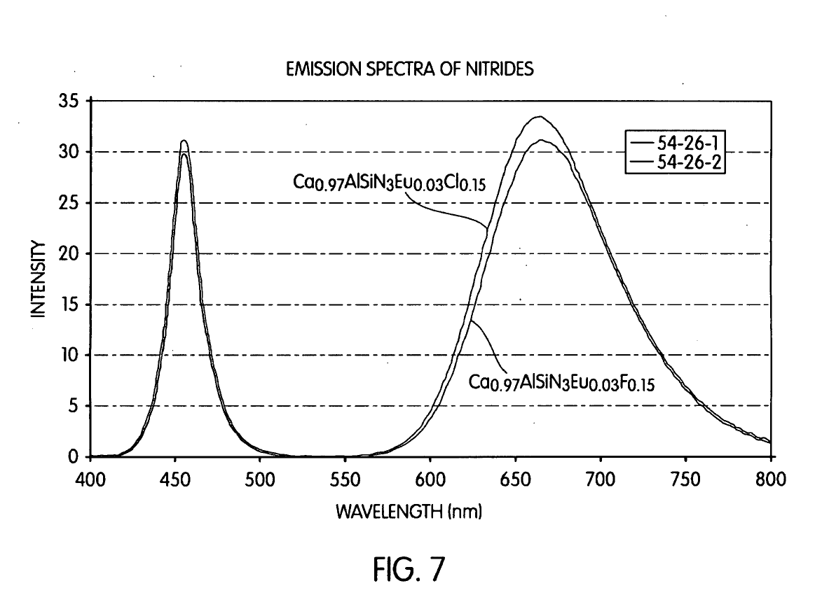

In summary, then, the exemplary phosphors Ca_{0.97}AlSiN₃Eu_{0.03}Cl_{0.15} and Ca_{0.97}AlSiN₃Eu_{0.03}F_{0.15} have an oxygen content less than about 2 weight percent, and are brighter than their non-halogen containing counterparts. The emission spectra of these exemplary nitride-based red phosphors is shown in FIG. 7 where interestingly, the chloride containing phosphor is slightly brighter than the fluorine containing phosphor. The spectra of these exemplary red phosphors is shown because in a subsequent section, the light from these red phosphors will be combined with, in various ratios and combinations, blue light from an LED (about 450 nm), and orange, green, and yellow light from certain silicate-based phosphors. That the present red materials are crystalline is shown by the x-ray diffraction pattern of FIG. 8.

### Excitation Spectra of the Present Nitride-Based Red Phosphors

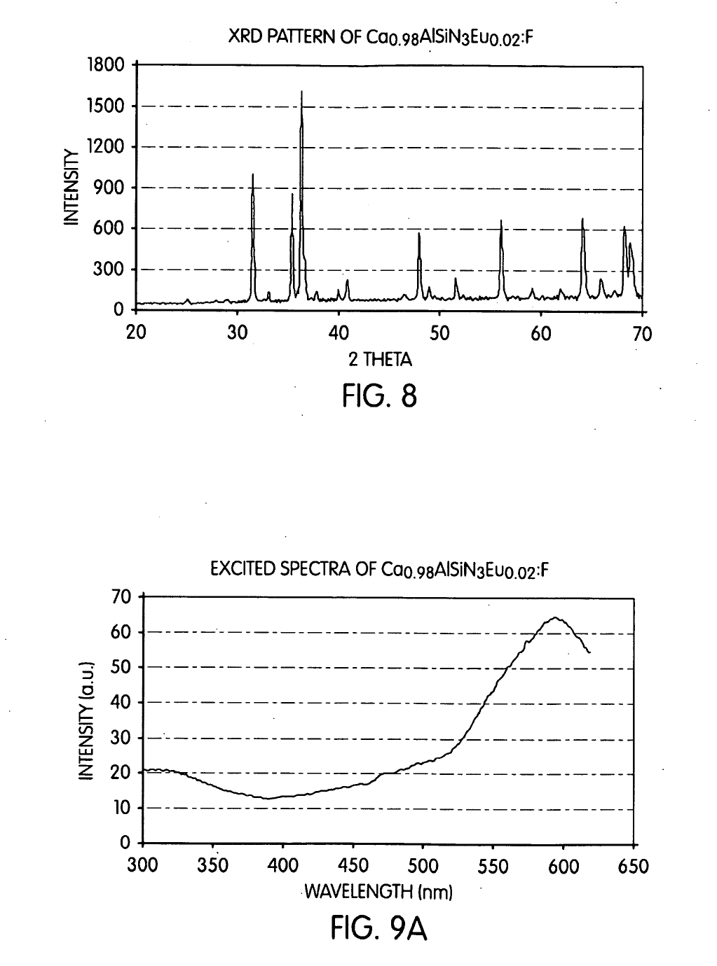

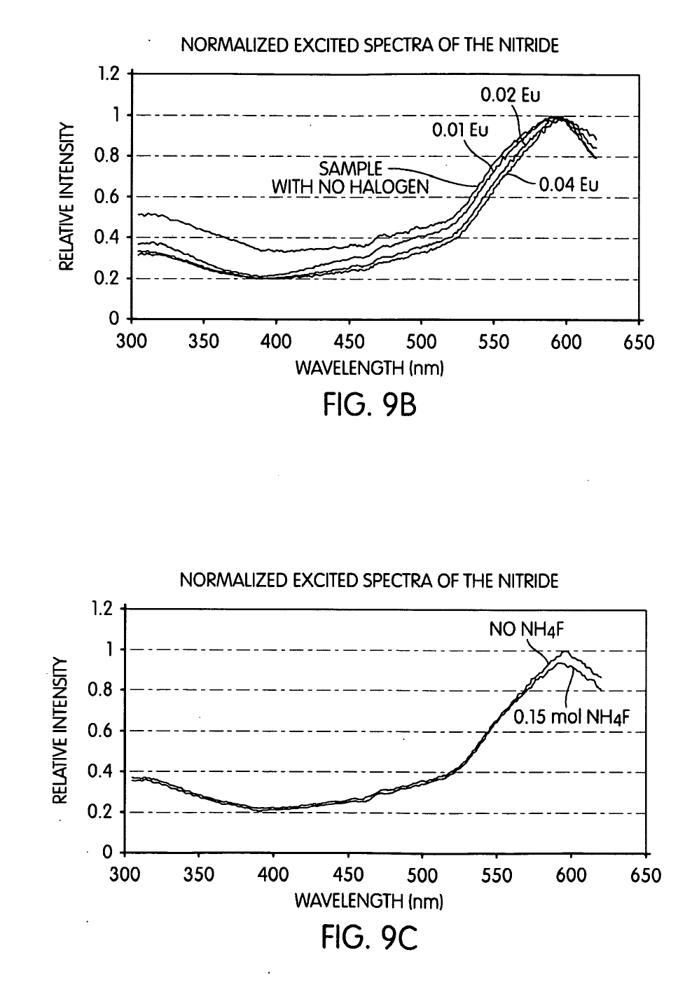

The present nitride-based red phosphors are capable of being excited at wavelengths ranging from about 300 nm to about 610 nm, as shown in FIGS. 9A-9C. FIG. 9A is an excitation spectra for the phosphor Ca_{0.98}AlSiN₃Eu_{0.02}:F.

Normalized excitation spectra for phosphors having the generalized formula Ca₁₋ₓAlSiN₃Euₓ are shown in FIG. 9B for Eu contents of 0.01, 0.02, and 0.04, where EuF₃ is used for the europium source, and no NH₄F flux was added. Normalized excitation spectra for phosphors having different fluorine contents is shown in FIG. 9C, where one sample of Ca_{0.97}AlSiN₃Eu_{0.03}Fₓ had 0.15 moles of NH₄F, and the other contained no flux. EuF₃ was the europium source for both samples. Both samples are efficient at absorbing excitation radiation ranging from about 300 nm to about 610 nm.

### High CRI and Production of Warm White Light

According to further embodiments of the present invention, the present red phosphors may be used in white light illumination systems, commonly known as “white LEDs.” Such white light illumination systems comprise a radiation source configured to emit radiation having a wavelength greater than about 280 nm; and a halide anion-doped red nitride phosphor configured to absorb at least a portion of the radiation from the radiation source, and emit light with a peak intensity in a wavelength range greater than about 640 nm. Exemplary spectra of light intensity versus wavelength emitted by these warm white luminescent systems are shown in FIGS. 10A-10D.

An example of a high CRI, warm-white lighting system made available to the industry as a result of the present red contribution is shown in FIG. 10A. Here, the instant red phosphor was combined with a yellow and green silicate-based phosphor. The yellow and green silicate-based phosphors were of the type M₂SiO₄:Eu²⁺, where M is a divalent alkaline earth metal such as Mg, Ba, Sr, and Ca. In this case, the yellow phosphor had the formula Sr_{1.46}Ba_{0.45}Mg_{0.05}Eu_{0.1}Si_{1.03}O₄Cl_{0.18}. The green phosphor in the case of FIG. 10A was (Sr_{0.575}Ba_{0.4}Mg_{0.25})₂Si(O,F)₄:Eu²⁺; another possibility for the green phosphor is Sr_{0.925}Ba_{1.025}Mg_{0.05}Eu_{0.06}Si_{1.03}O₄Cl_{0.12}. The red phosphor was Ca_{0.97}AlSiN₃Eu_{0.03}:Cl_{0.1} according to the present embodiments. This system was designed to be combined with the blue light from a 450 nm emitting chip to create “warm white light” having the properties: CIE x was 0.439, CIE y was 0.404, the color coordinated temperature CCT was 2955, and the CRI was 90.2. It will be understood that the 450 nm blue LED serves two roles: 1) to excite the phosphors in the system, and 2) to contribute a blue light component to the resultant warm white light.

A second example of a high CRI, warm-white lighting system is shown in FIG. 10B. Here, an exemplary present nitride-based red phosphor was combined with an orange and a green silicate-based phosphor to generate white light. The orange phosphor was of the type M₃SiO₅:Eu²⁺, where again M is a divalent alkaline earth metal such as Mg, Ba, Sr, and Ca. In this case the orange phosphor had the formula Sr₃Eu_{0.06}Si_{1.02}O₅F_{0.18}. This system (again with a 450 nm blue LED excitation source) produced a warm white light having the following properties: CIE x was 0.438, CIE y was 0.406, the color coordinated temperature CCT was 2980, and the CRI was 90.3. See FIG. 10B.

A third example of a high CRI, warm-white lighting system is shown in FIG. 10C. Here a silicate-based green phosphor having the formula (Sr_{0.575}Ba_{0.4}Mg_{0.025})₂Si(O,F)₄:Eu²⁺ was combined with an exemplary nitride-based red phosphor having the formula Ca_{0.97}AlSiN₃Eu_{0.03}:F to produce a warm white light having the following properties: CIE x was 0.3, CIE y was 0.3, the color coordinated temperature CCT was 7735, and the CRI was 76. Another possibility for the green phosphor is Sr_{0.925}Ba_{1.025}Mg_{0.05}Eu_{0.06}Si_{1.03}O₄Cl_{0.12}. Again, the blue LED emitted at about 450 nm. See FIG. 10C.

The success of the present nitride-based red phosphors at providing solutions to the warm white light industry may be seen in the context of FIG. 10D. This graphs illustrates a dilemma the designer of such a system faces: the conflict between achieving a high brightness system, characterized by the curve V(λ) in FIG. 10D, with a high CRI (color rendering index), such as that portrayed by the black body radiator in FIG. 10D. It will be understood that the V(λ) curve is the standard luminosity function (dimensionless), which describes the average sensitivity of the human eye to light of different wavelengths. It is a standard function provided by the Commission Internationale de I'Éclairage (CIE) for converting radiant energy into luminous energy.

The white light illumination system in FIG. 10D comprises an exemplary nitride-based red phosphor according to the present embodiments in combination with an M₂SiO₄:Eu³⁺ green silicate-based phosphor with an M₃SiO₅:Eu²⁺ orange silicate-based phosphor. The present inventors believe this is the best warm white LED-based illumination system available to date.

What is claimed is:

1. A nitride-based red phosphor having the formula M-A-B—(N,D):Z, wherein:
M is a divalent element;
A is a trivalent element
B is a tetravalent element
N is nitrogen
Z is an activator; and
D is a halogen;
wherein the phosphor is configured to emit visible light having a peak emission wavelength greater than about 620 nm.

2. The nitride-based red phosphor of claim 1, wherein the oxygen content is less than about 2 percent by weight.

3. A nitride-based red phosphor having the formula MₘMₐM_{b}(N,D)ₙ:Z_{z}, wherein:
Mₘ is a divalent element;
Mₐ is a trivalent element
M_{b} is a tetravalent element
N is nitrogen
Z is an activator; and
D is a halogen;
wherein the stiochiometry of the constituent elements (m+z):a:b:n is about 1:1:1:3, and the phosphor is configured to emit visible light having a peak emission wavelength greater than about 620 nm.

4. The nitride-based red phosphor of claim 3, wherein the oxygen content is less than about 2 percent by weight.

5. A nitride-based red phosphor having the formula MₘMₐM_{b}D_{3w}N_{[(2/3)m+z+a+(4/3)b-w]}Z_{z}, wherein:
Mₘ is a divalent element selected from the group consisting of Be, Mg, Ca, Sr, Ba, Zn, Cd, and Hg;
Mₐ is a trivalent element selected from the group consisting of B, Al, Ga, In, Y, Sc, P, As, La, Sm, Sb, and Bi;
M_{b} is a tetravalent element selected from the group consisting of C, Si, Ge, Sn, Ni, Hf, Mo, W, Cr, Pb, Ti, and Zr;
D is a halogen selected from the group consisting of F, Cl, Br, and I;
Z is an activator selected from the group consisting of Eu, Ce, Mn, Tb, and Sm;
N is nitrogen; where
0.01≦m≦1.5;
0.01≦a≦1.5;
0.01≦b≦1.5;
0.0001≦w≦0.6, and
0.0001≦z≦0.5;
wherein the phosphor is configured to emit visible light having a peak emission wavelength greater than about 620 nm.

6. The nitride-based red phosphor of claim 5, wherein the oxygen content is less than about 2 percent by weight.

7. A nitride-based red phosphor having the formula M-A-B—N:Z, wherein:
M is a divalent element;
A is a trivalent element;
B is a tetravalent element;
N is nitrogen;
Z is an activator; and
D is a halogen;
wherein the phosphor is configured to emit visible light having a peak emission wavelength greater than about 620 nm, and wherein the oxygen content is less than about 2 percent by weight.

8. A nitride-based red phosphor having the formula MₘMₐM_{b}Nₙ:Z_{z}, wherein:
Mₘ is a divalent element;
Mₐ is a trivalent element;
M_{b} is a tetravalent element;
N is nitrogen
Z is an activator; and
D is a halogen;
wherein the stiochiometry of the constituent elements (m+z):a:b:n is about 1:1:1:3, and the phosphor is configured to emit visible light having a peak emission wavelength greater than about 620 nm, and wherein the oxygen content is less than about 2 percent by weight.

9. A nitride-based red phosphor having the formula MₘMₐM_{b}D_{3w}N_{[(2/3)m+z+a+(4/3)b-w}]Z_{z}, wherein:
Mₘ is a divalent element selected from the group consisting of Be, Mg, Ca, Sr, Ba, Zn, Cd, and Hg;
Mₐ is a trivalent element selected from the group consisting of B, Al, Ga, In, Y, Sc, P, As, La, Sm, Sb, and Bi;
M_{b} is a tetravalent element selected from the group consisting of C, Si, Ge, Sn, Ni, Hf, Mo, W, Cr, Pb, Ti, and Zr;
D is a halogen selected from the group consisting of F, Cl, Br, and I;
Z is an activator selected from the group consisting of Eu, Ce, Mn, Tb, and Sm;
N is nitrogen; where
0.01≦m≦1.5;
0.01≦a≦1.5;
0.01≦b≦1.5;
0.0001≦w≦0.6, and
0.0001≦z≦0.5;
wherein the phosphor is configured to emit visible light having a peak emission wavelength greater than about 620 nm.

10. The nitride-based red phosphor of claim 9, wherein the oxygen content is less than about 2 percent by weight.
